(19) United States
(12) Patent Application Publication
(10) Pub. No.: US 2010/0216492 A1
(43) Pub. Date: Aug. 26, 2010

(54) EMPLOYMENT OF A TEXT MESSAGE BY A USER OF A FIRST MOBILE TELEPHONE TO INVOKE A PROCESS THAT PROVIDES INFORMATION TO A USER OF A SECOND MOBILE TELEPHONE

(75) Inventors: Daphna Steinmetz, Ramat Gan (IL); Alex Rivkin, Mevaseret Zion (IL)

Correspondence Address: OHLANDT, GREELEY, RUGGIERO & PERLE, LLP, ONE LANDMARK SQUARE, 10TH FLOOR, STAMFORD, CT, 06901, US

(73) Assignee: COMVERSE, LTD., Tel Aviv (IL)

(21) Appl. No.: 12/706,184

(22) Filed: Feb. 16, 2010

Related U.S. Application Data
(60) Provisional application No. 61/152,787, filed on Feb. 16, 2009.

(51) Int. Cl. H04W 4/12; H04W 4/02

(52) U.S. Cl. 455/457; 455/466

(57) ABSTRACT

There is provided a method that includes (a) receiving a text message that was sent from a first user device via a communications network, (b) detecting a text string in the text message, (c) executing a process, in response to detecting the text string, wherein the executing yields a result, and (d) sending the result to a second user device via the communications network. In an exemplary embodiment, a user of a first mobile telephone uses an SMS message to invoke a process that provides, to a user of a second mobile telephone, a map that shows a location of the first mobile telephone.

### BACKGROUND OF THE INVENTION

1. Field of the Invention

The present disclosure relates to mobile telephone communications, and more particularly, to a use of a text message by a user of a first mobile telephone to invoke a process that provides information to a user of a second mobile telephone. In an exemplary embodiment, the user of the first mobile telephone uses a short message service (SMS) message to invoke a process that provides, to a user of the second mobile telephone, a map that shows a location of the first mobile telephone.

2. Description of the Related Art

Assume a wireless communication session being conducted between a first user having a first wireless telephone, and a second user having a second wireless telephone. The first user may wish for the second user to be presented with some information, for example, a map, that the first user cannot readily communicate to the second user. There is a need to a method in which the first user can invoke a process that provides the information to the second user.

### SUMMARY OF THE INVENTION

There is provided a method that includes (a) receiving a text message that was sent from a first user device via a communications network, (b) detecting a text string in the text message, (c) executing a process, in response to detecting the text string, wherein the executing yields a result, and (d) sending the result to a second user device via the communications network. In an exemplary embodiment, a user of a first mobile telephone uses an SMS message to invoke a process that provides, to a user of a second mobile telephone, a map that shows a location of the first mobile telephone.

### BRIEF DESCRIPTION OF THE DRAWINGS

FIG. 1 is a block diagram of a communications system.

FIG. 2 is a combination of a block diagram and a flow diagram for an exemplary communication session.

FIGS. 3-9 are illustrations of several events occurring during a communication session.

A component or a feature that is common to more than one drawing is indicated with the same reference number in each of the drawings.

### DESCRIPTION OF THE INVENTION

Short Message Service (SMS) is a communication service component of the Global System for Mobile Communications (GSM) mobile communication system, using standardized communications protocols that allow an exchange of short text messages, i.e., an SMS message, between mobile phone devices. The SMS message can be up to 160 characters in length, including spaces. The SMS message also includes a unique identifier, such as a telephone number, for each of a user device that sends the SMS message, and a user device that is the intended recipient of the SMS message. The term SMS is used herein as a synonym for all types of short text messaging, and is not necessarily limited to SMS in the GSM system.

An SMS center (SMSC) is a facility that is responsible for routing and regulating SMS operations of a wireless network. When an SMS message is sent from a sending device, e.g., a mobile phone, the SMS message is directed to an SMSC that will then forward the SMS message to a recipient device, e.g., another mobile phone. The SMSC also stores the SMS messages if the recipient device is unavailable, and thereafter sends the SMS message to the recipient device when the recipient device becomes available.

An instant messenger is a computer application that allows instant text communication between two or more people through a network such as the Internet. Instant messaging, often shortened to simply “IM” or “IMing,” is the exchange of text messages through the computer application, in real-time. Mobile cellular phone technology also allows mobile telephone handset users to communicate via IM.

Multimedia Messaging Service (MMS) is a standard developed by Third Generation Partnership Project (3GPP) for communicating messages that include multimedia content. An MMS message also includes a unique identifier, such as a telephone number, for each of a user device that sends the MMS message, and a user device that is the intended recipient of the MMS message. A popular use of MMS is to send photographs from camera-equipped handsets. The term MMS is used herein as a synonym for all types of multimedia messaging, and is not necessarily limited to the standard developed by 3GPP.

An MMS center (MMSC) is a facility that is responsible for routing and regulating MMS operations of a wireless network. When an MMS message is sent from a sending device, e.g., a mobile phone, the MMS message is directed to an MMSC that will then forward the MMS message to a recipient device, e.g., another mobile phone. The MMSC also stores the MMS messages if the recipient device is unavailable, and thereafter sends the MMS message to the recipient device when the recipient device becomes available.

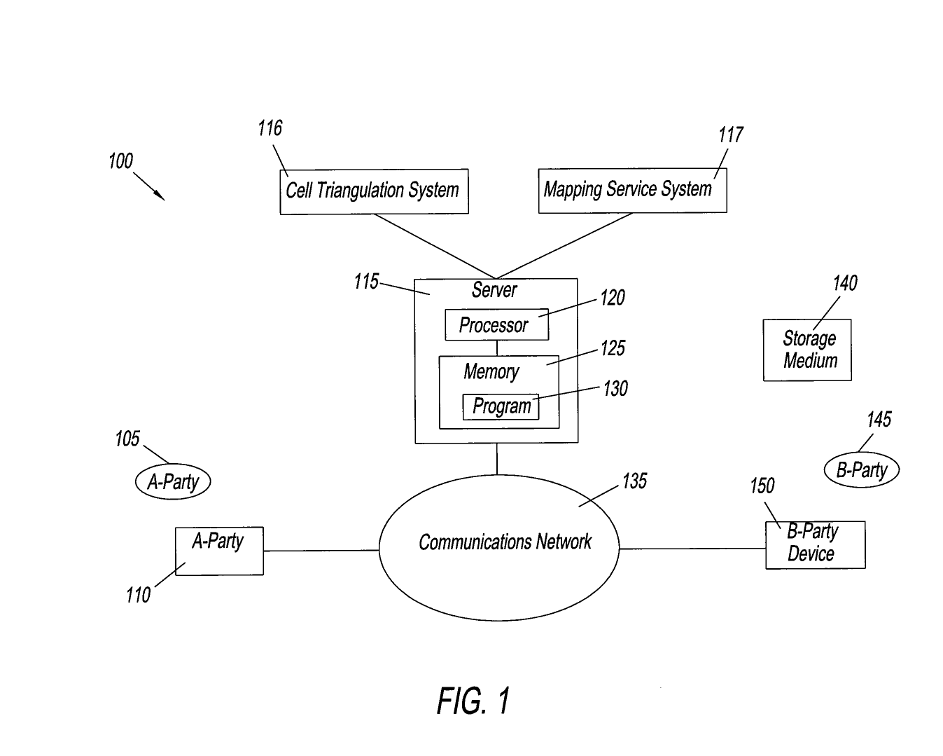

FIG. 1 is a block diagram of a communications system 100 in which an A-party 105 using an A-party device 110 communicates, via a communications network 135, with a B-party 145 using a B-party device 150. A server 115 is also coupled to communications network 135.

Communications network 135 includes a telephone network that supports wireless telephone communications, and a data network, such as the Internet, that supports data communications.

A-party device 110 includes a user interface for audio communications, and preferably, also includes a display, and a keyboard for entry of data and commands. A mobile telephone, or a personal digital assistant having a telephone capability, are suitable examples. A-party device 110 is capable of sending and receiving text messages, for example SMS messages or instant messages, and is also capable of sending multimedia messages, for example MMS messages. For purposes of the present disclosure, assume that A-party device 110 is a mobile telephone that includes a display.

B-party device 150 has features similar to those of A-party device 110. For purposes of the present disclosure, assume that B-party device 150 is a mobile telephone that includes a display.

Server 115 includes a processor 120 and a memory 125.

Processor 120 is configured of logic circuitry that responds to and executes instructions. Processor 120 may also be regarded as a computer, and may be physically configured as either of a single processing device, as shown in FIG. 1, or as plurality of processing devices having processing responsibilities distributed among them.

Memory 125 is a computer-readable medium encoded with a computer program, i.e., program 130. Memory 130 may be implemented in a random access memory (RAM), a hard drive, a read only memory (ROM), or a combination thereof. Memory 125, similarly to processor 120, may be configured as either of a single memory device, as shown in FIG. 1, or as a plurality of memory devices having data and instructions distributed among them.

Program 130 contains instructions that are in a form that is readable by processor 120, and the instructions, when read by processor 120, cause processor 120 to execute methods, described herein, attributable to server 115. Program 130 may be implemented as a single module or as a plurality of modules that operate in cooperation with one another. Although program 130 is described herein as being installed in memory 125, and therefore being implemented in software, it could be implemented in any of hardware, e.g., electronic circuitry, firmware, software, or a combination thereof.

Although system 100 is described herein as having program 130 installed into memory 125, program 130 can be tangibly embodied and stored on an external computer-readable storage medium 140 for subsequent loading into memory 125. Storage medium 140 can be any conventional storage medium, including, but not limited to, a floppy disk, a compact disk, a magnetic tape, a read only memory, an optical storage media, universal serial bus (USB) flash drive, a digital versatile disc, or a zip drive. Program 130 could also be embodied in a random access memory, or other type of electronic storage, located on a remote storage system and coupled to memory 125.

Server 115 processes SMS messages, and as such, serves as, or is a component of, an SMSC. For example, when A-party 105 sends an SMS message to B-party 145, and more specifically, when A-party device 110 sends an SMS message to B-party device 150, server 115 stores the SMS message and delivers it to B-party device 150 when B-party device 150 is available. Server 115 is also capable of generating SMS messages.

Server 115 also processes MMS messages, and as such, serves as, or may be a component of, an MMSC. For example, when A-party 105 sends an MMS message to B-party 145, and more specifically, when A-party device 110 sends an MMS message to B-party device 150, server 115 stores the MMS message and delivers it to B-party device 150 when B-party device 150 is available. Server 115 is also capable of generating MMS messages.

Assume that A-party 105 wishes for B-party 145 to have some information. To facilitate the provision of the information, server 115 performs a method that includes (a) receiving a text message that was sent from A-party device 110 via communications network 135, (b) detecting a text string in the text message, (c) executing a process, in response to detecting the text string, where the executing yields a result, i.e., the information, and (d) sending the information to B-party device 150 via communications network 135. The text message may be, for example, an SMS message or an IM.

Server 115 is also coupled to a cell triangulation system 116 and a mapping service system 117.

Cell triangulation system 116 is a system for determining a location of a user device, e.g., a mobile telephone, such as A-party device 110. When a mobile telephone, is turned on, the mobile telephone searches for a signal to confirm that mobile service is available. Then the mobile telephone transmits certain identification numbers, so the telephone network can verify customer information-such as the customer's wireless provider and telephone number. When given a telephone number or other unique identifier of the mobile telephone, cell triangulation system 116 identifies a plurality of cellular towers that are within a communicating range of the mobile telephone, and based on relative time delays in signals from the mobile telephone to the cellular towers, cell triangulation system 116 determines the location of the mobile telephone.

Mapping service system 117 is a system for generating a map. More specifically, when given a location, mapping service system 117 generates a map having the location indicated thereon. Additionally, when given a first location and a second location, mapping service system generates a routing map, from the first location to the second location, and also provides turn-by-turn directions from the first location to the second location in written form.

Although cell triangulation system 116 and mapping service system 117 are shown in FIG. 1 as being external to server 115, they can be components of server 115. The relative physical locations of server 115, cell triangulation system 116 and mapping service system 117 are not critical to the operation of system 100. As such, processor 120, in accordance with instructions contained within memory 125, may perform operations of all of server 115, cell triangulation system 116 and mapping service system 117.

Assume that A-party 105 wishes for B-party 145 to know the location of A-party 105. A convenient manner of representing that location would be by way of a map. To facilitate the presentation of the map, server 115 performs a method that includes (a) receiving an SMS message from A-party device 110 via communications network 135, (b) detecting a text string in the SMS message, (c) obtaining, upon detection of the text string, a location of A-party device 110, (d) obtaining a map having the location indicated thereon, and (e) sending, to B-party device 150 via communications network 135, a communication that facilitates a display of the map on B-party device 150. The communication could be either of (i) an SMS message that contains a link to a storage that has the map stored therein, or (ii) a multimedia media service (MMS) message that includes an image of the map.

One of the benefits provided by system 100, and more particularly server 115, is that neither of A-party device 110 nor B-party device needs to have any special-purpose software or hardware installed therein. In other words, each of A-party device 110 and B-party device can be conventional devices. Server 115 provides all of the functionality of the methods presented herein.

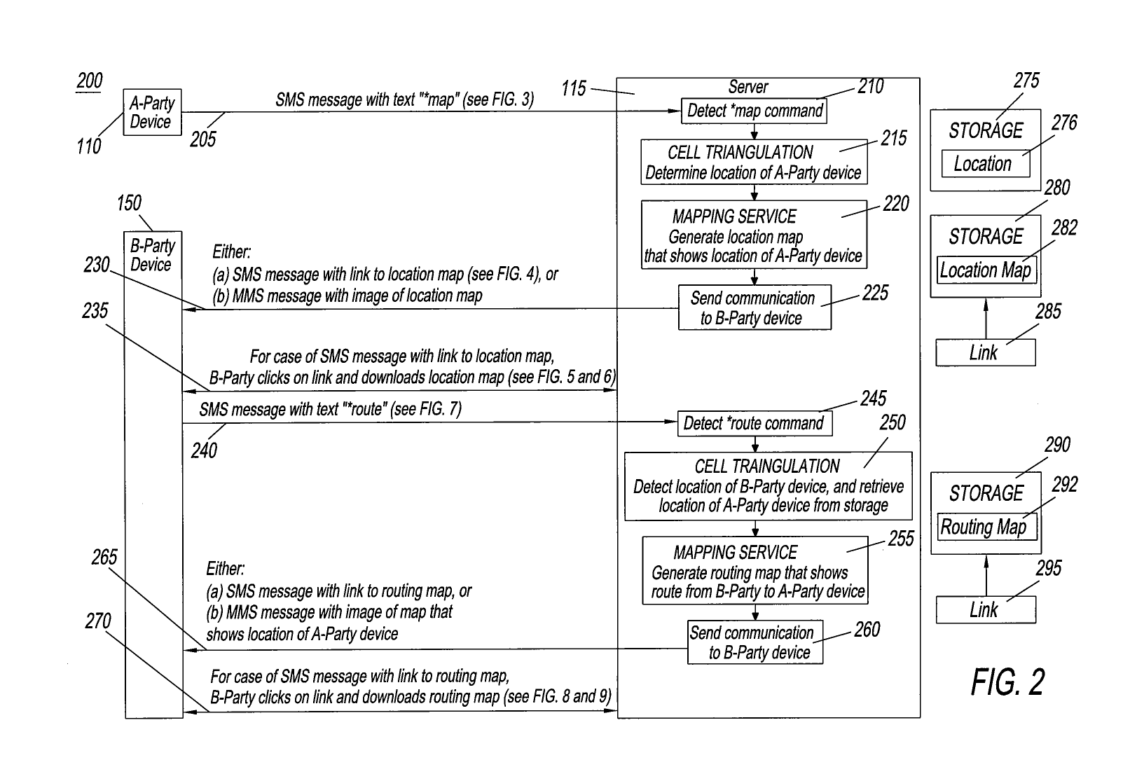

FIG. 2 is a combination of a block diagram and a flow diagram for an exemplary communication session 200 in which A-party 105 wishes for B-party 145 to know the location of A-party 105. As explained below, server 115 (a) prepares a location map that shows the location of A-party device 110, and (b) sends, to B-party device 150, a communication that facilitates a display of the location map on B-party device 150. Also in communication session 200, B-party 145 desires a routing map from the location of B-party device 150 to the location of A-party device 110. Accordingly, server 115 (a) prepares a routing map that shows a route from the location of B-party device 150 to the location of A-party device 110, and (b) sends, to B-party device 150, a communication that facilitates a display of the routing map on B-party device 150. The relevant portion of communication session 200 commences with step 205.

In step 205, A-party 105 prepares an SMS message that includes a particular text string, e.g., “map”, and A-party device 110 sends the SMS message via communications network 135. From step 205, communication session 200 progresses to step 210.

In step 210, server 115 receives the SMS message and detects the text string, and in response to the detection of the text string, executes a process. In the present example, server 115 interprets the text string “*map” as a command to invoke a process to determine a location of A-party device 110, and prepare a map. As mentioned above, an SMS message also includes a unique identifier, such as a telephone number, for each of a user device that sends the SMS message, and a user device that is the intended recipient of the SMS message. From the SMS message, server 115 reads the unique identifier, e.g., telephone number, of each of A-party device 110 and B-party device 150. From step 210, communication session 200 progresses to step 215.

In step 215, server 115 obtains a location of A-party device 110. More specifically, (i) server 115 sends the telephone number of A-party device 110 to cell triangulation system 116, and (ii) cell triangulation system 116, in turn, determines a location of A-party device 110, and returns the location to server 115. Server 115 saves the location as location 276 in a storage 275. Storage 275 could be a component of, or an address within, memory 125. From step 215, communication session 200 progresses to step 220.

In step 220, server 115 obtains a map having the location of A-party device 110 indicated thereon. More specifically, (i) server 115 sends location 276 to mapping service system 117, and (ii) mapping service system 117, in turn, generates a location map that has the location of A-party device 110 indicated thereon, and sends the location map to server 115. Server 115 saves the location map as location map 282 in a storage 280. Storage 280 could be a component of, or an address within, memory 125. From step 220, communication session 200 progresses to step 225.

In step 225, server 115 sends, to B-party device 150, via communications network 135, a communication 230 that facilitates a display of the location map on B-party device 150. Communication 230 can be either of (i) an SMS message that contains a link 285, e.g., an address pointer or a uniform resource locator (URL), to storage 280, or (ii) an MMS message that includes an image of location map 282.

For the case of communication 230 being an SMS message that contains link 285, after B-party device 150 receives communication 230, B-party 145 clicks on link 285, and via an exchange of communications 235, downloads location map 282. Clicking link 285 automatically activates a mobile Internet web browser (not shown) on B-party device 150, which accesses storage 282. The mobile Internet browser connects to storage 282 via a cellular network, or via a wireless local area network (LAN), using standard HyperText Transfer Protocol (HTTP) over Transmission Control Protocol/Internet Protocol (TCP/IP) and displays web pages written in Hyper Text Markup Language (HTML), eXtensible Hypertext Markup Language Mobile Profile (XHTML MP) Wireless Application Protocol (WAP) 2.0. Thereafter, B-party device 150 presents the downloaded location map on a display of B-party device 150.

For the case of communication 230 being an MMS message that includes an image of location map 282, B-party device 150 presents the image on a display of B-party device 150.

As mentioned above, in communication session 200, B-party 145 desires a routing map from the location of B-party device 150 to the location of A-party device 110. Accordingly, communication session 200 proceeds with step 240.

In step 240, B-party 145 prepares an SMS message that includes a particular text string, e.g., *route”, and B-party device 150 sends the SMS message via communications network 135. From step 240, communication session 200 progresses to step 245.

In step 245, server 115 receives the SMS message and detects the text string. Server 115 interprets the text string, e.g., *route, as a command to invoke a process to prepare determine a location of B-party device 150, and prepare a routing map. From the SMS message, server 115 reads the unique identifier, e.g., telephone number, of each of A-party device 110 and B-party device 150. From step 245, communication session 200 progresses to step 250.

In step 250, server 115 obtains a location of B-party device 150. More specifically, (i) server 115 sends the telephone number of B-party device 150 to cell triangulation system 116, and (ii) cell triangulation system 116, in turn, determines a location of B-party device 150, and returns, to server 115, the location of B-party device 150. Also in step 250, server 115 retrieves, from storage 275, location 276, i.e., the location of A-party device 110. Thus, server 115 has the location of B-party device 150 and the location of A-party device 110. From step 250, communication session 200 progresses to step 255.

In step 255, server 115 obtains a map that shows a route from B-party device 150 to A-party device 110. More specifically, (i) server 115 sends location 276, i.e., the location of A-party device 110, and the location of B-party device 150, to mapping service system 117, and (ii) mapping service system 117, in turn, generates a routing map that shows a route from B-party device 150 to A-party device 110. The routing map may include turn-by-turn directions from the location of B-party device 150 to the location of A-party device 110, in written form. Mapping service system 117 sends the routing map to server 115, and server 115 saves the routing map as routing map 292 in a storage 290. Storage 290 could be a component of, or an address within, memory 125. From step 255, communication session 200 progresses to step 260.

In step 260, server 115 sends, to B-party device 150, via communications network 135, a communication 265 that facilitates a display of the routing map on B-party device 150. Communication 265 can be either of (i) an SMS message that contains a link 295, e.g., an address pointer or a uniform resource locator (URL), to storage 290, or (ii) an MMS message that includes an image of routing map 292.

For the case of communication 265 being an SMS message that contains link 295, after B-party device 150 receives communication 265, B-party 145 clicks on link 295, and via an exchange of communications 270, downloads routing map 292. Thereafter, B-party device 150 presents the downloaded routing map on a display of B-party device 150.

For a case of communication 265 being an MMS message that includes an image of routing map 292, B-party device 150 presents the image on a display of B-party device 150.

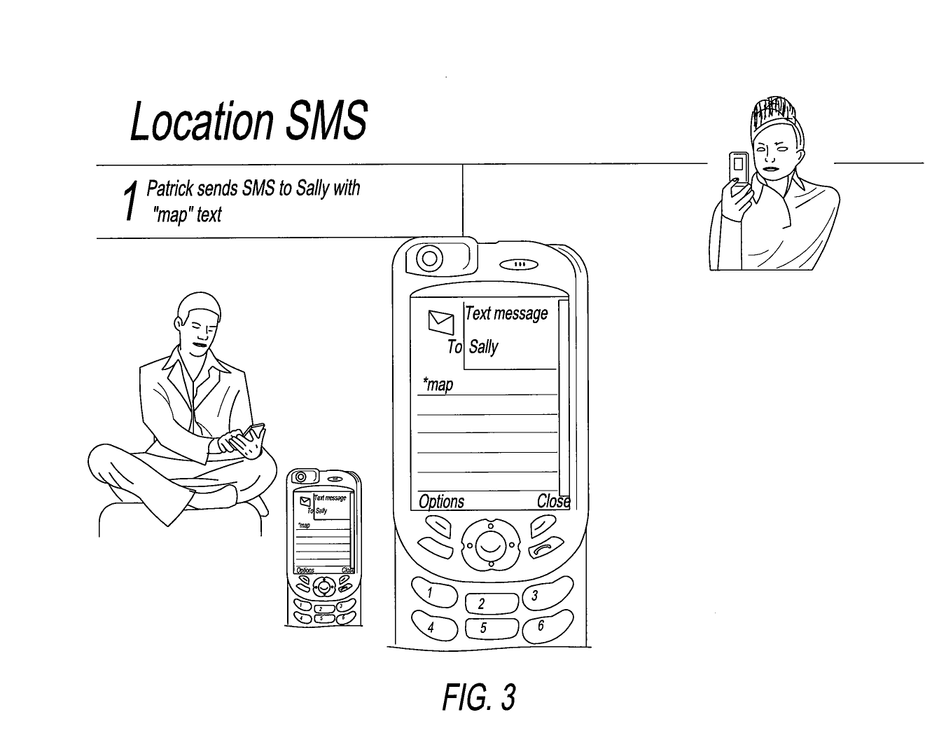

FIGS. 3-9 are illustrations of several events occurring during a communication session between an A-party, i.e. Patrick, and a B-party, i.e., Sally. Each of Patrick and Sally is using a mobile phone. Patrick wishes for Sally to know Patrick's location. FIGS. 3-9 are examples of activities described above, with reference to FIG. 2.

In FIG. 3, Patrick is sending an SMS message to Sally, with the text string, “map”. This is an example of the activity in step 205.

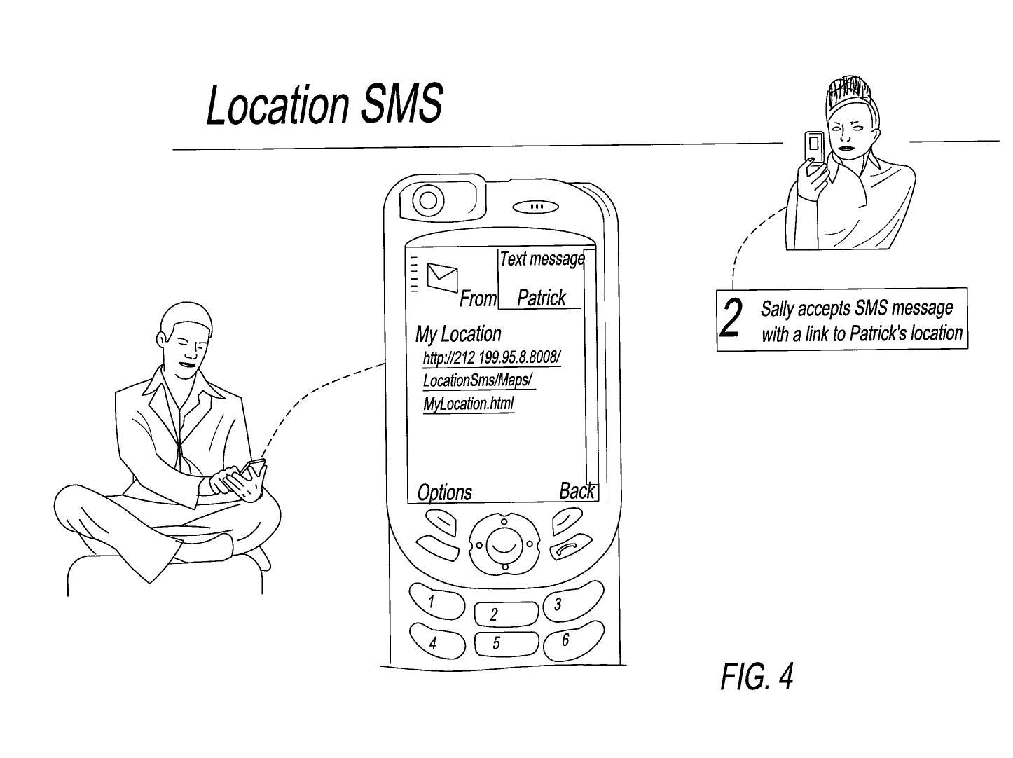

In FIG. 4, Sally is accepting an SMS message that contains a link to Patrick's location. This SMS message is an example of communication 230 being an SMS message that contains link 285.

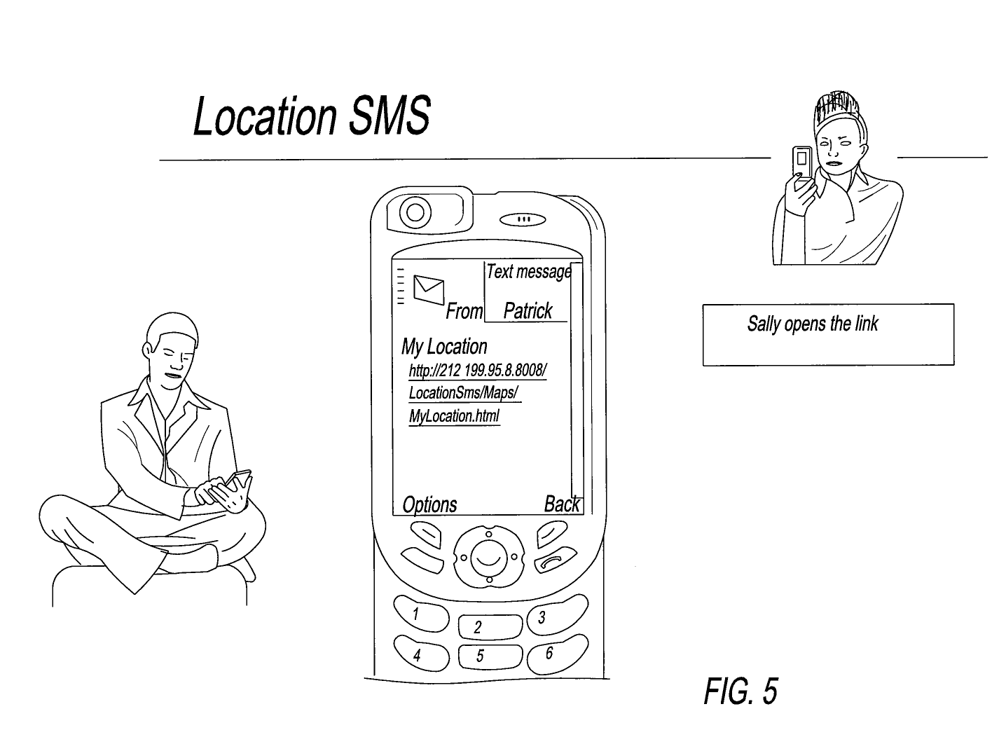

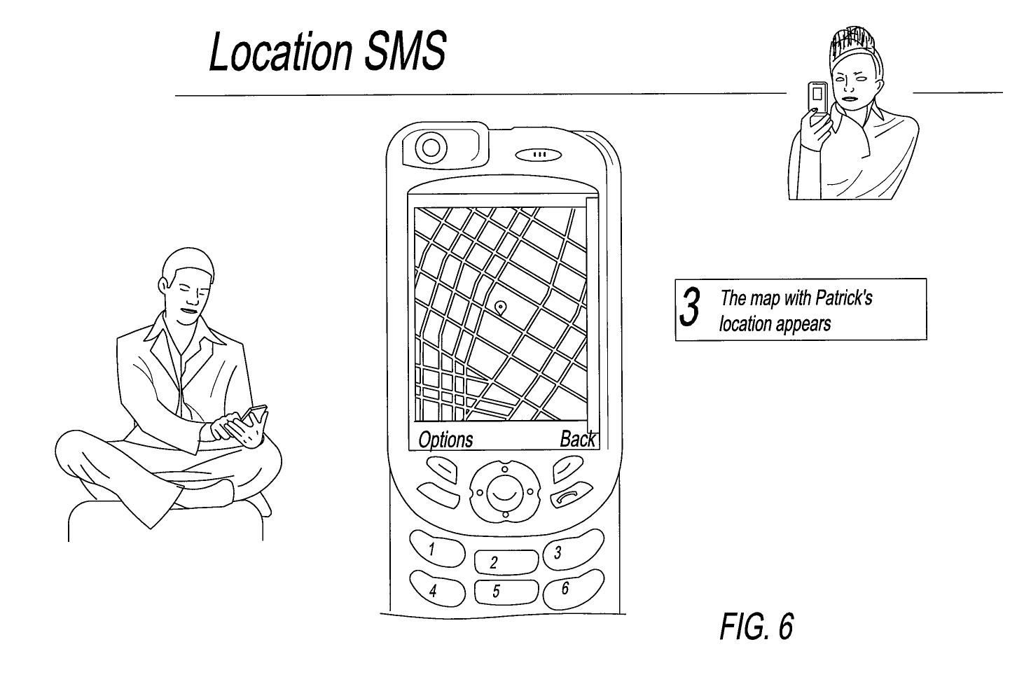

In FIG. 5, Sally is opening the link, and in FIG. 6, a map with Patrick's location is being displayed on Sally's mobile phone. FIGS. 5 and 6 are examples of activities occurring during the exchange of communications 235.

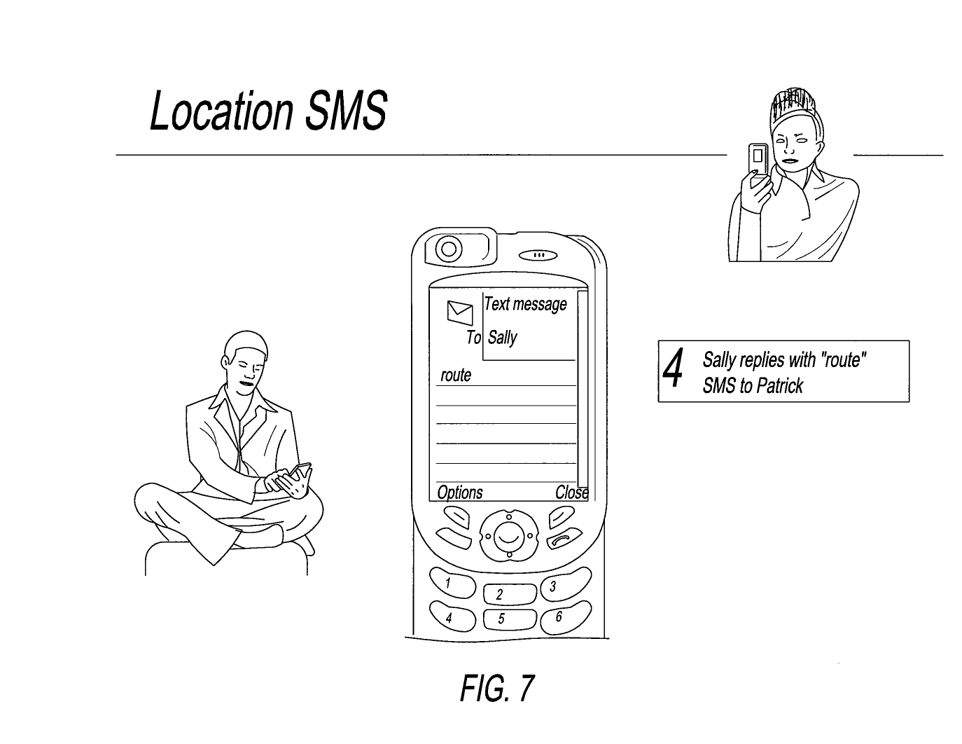

In FIG. 7, Sally is sending an SMS message that contains the text string, “*route”. This is an example of the activity in step 240.

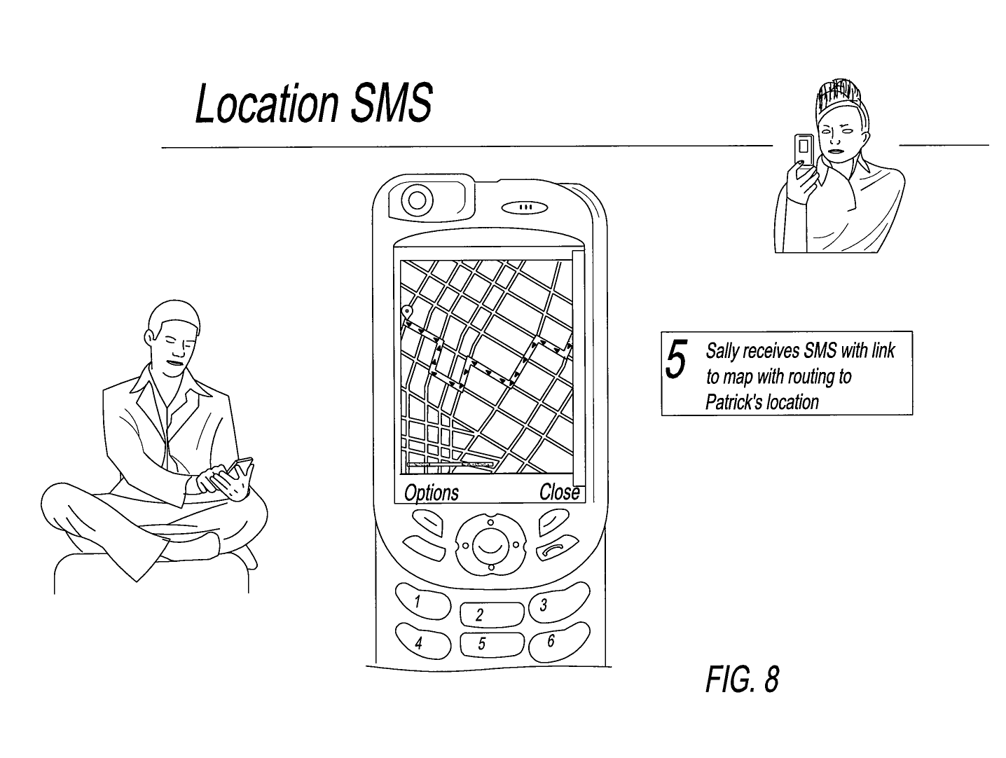

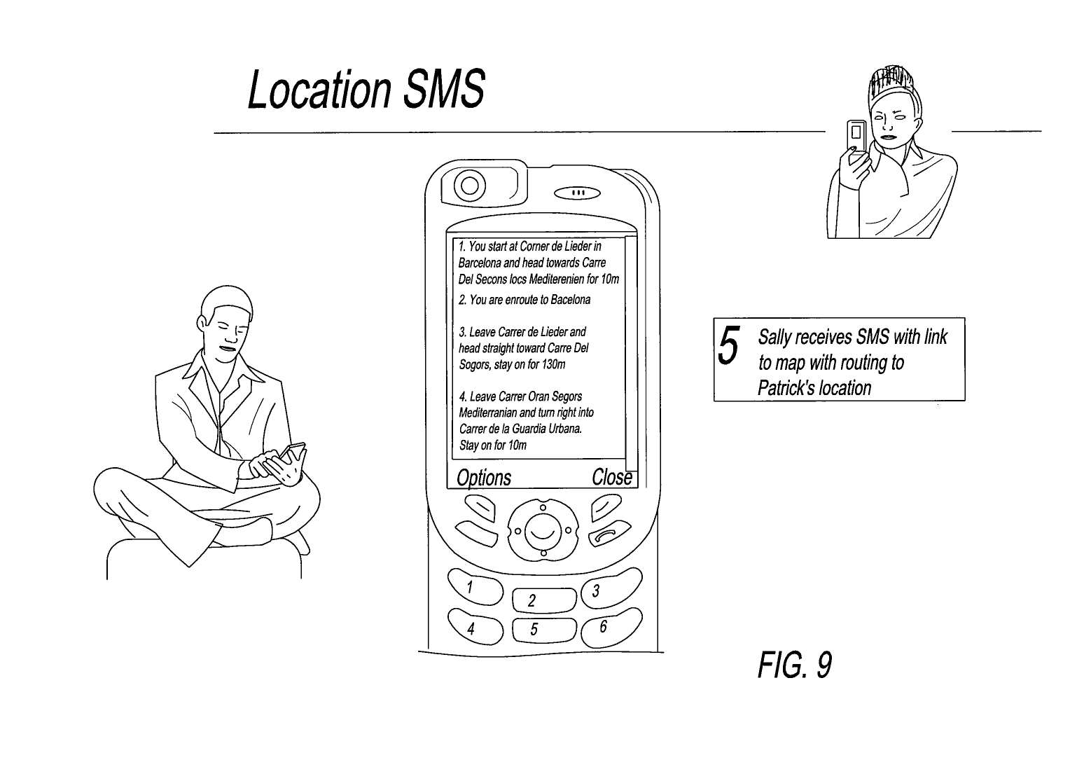

In FIG. 8, Sally has received, and opened, a link to a routing map that shows a route from Sally's mobile phone to Patrick's mobile phone. In FIG. 9, Sally's mobile phone is displaying turn-by-turn directions from Sally's mobile phone to Patrick's mobile phone. FIGS. 8 and 9 are examples of activities occurring during the exchange of communications 270.

The techniques described herein are exemplary, and should not be construed as implying any particular limitation on the present disclosure. It should be understood that various alternatives, combinations and modifications could be devised by those skilled in the art. Also, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system comprising:
a processor; and
a memory having instructions stored therein in a form that is readable by said processor, wherein said instructions, when read by said processor, cause said processor to perform actions of:
receiving a text message that was sent from a first user device via a communications network;
detecting a text string in said text message;
executing a process, in response to said detecting said text string, wherein said executing yields a result; and
sending said result to a second user device via said communications network.

2. The system of claim 1,
wherein said process comprises:
obtaining a location of said first user device; and
obtaining a map having said location indicated thereon, and
wherein said result comprises:
a communication that facilitates a display of said map on said second user device.

3. The system of claim 2, wherein said communication is selected from the group consisting of (i) a message that contains a link to a storage that has said map stored therein, and (ii) a message that includes an image of said map.

4. The system of claim 2,
wherein said text message is a first text message, said text string is a first text string, said map is a first map, and said communication is a first communication, and
wherein said instructions cause said processor to perform further actions of:
receiving a second text message that was sent from said second user device via said communications network;
detecting a second text string in said second text message;
obtaining, in response to said detecting said second text string, a location of said second user device;
obtaining a second map that shows a route from said location of said second user device to said location of said first user device; and
sending, to said second user device via said communications network, a second communication that facilitates a display of said second map on said second user device.

5. The system of claim 4, wherein said second communication is selected from the group consisting of (i) a message that contains a link to a storage that has said second map stored therein, and (ii) a message that includes an image of said second map.

6. A method comprising:
receiving a text message that was sent from a first user device via a communications network;
detecting a text string in said text message;
executing a process, in response to said detecting said text string, wherein said executing yields a result; and
sending said result to a second user device via said communications network.

7. The method of claim 6,
wherein said process comprises:
obtaining a location of said first user device; and
obtaining a map having said location indicated thereon, and
wherein said result comprises:
a communication that facilitates a display of said map on said second user device.

8. The method of claim 6, wherein said communication is selected from the group consisting of (i) a message that contains a link to a storage that has said map stored therein, and (ii) a message that includes an image of said map.

9. The method of claim 6,
wherein said text message is a first text message, said text string is a first text string, said map is a first map, and said communication is a first communication, and
wherein said method further comprises:
receiving a second text message that was sent from said second user device via said communications network;
detecting a second text string in said second text message;
obtaining, in response to said detecting said second text string, a location of said second user device;
obtaining a second map that shows a route from said location of said second user device to said location of said first user device; and
sending, to said second user device via said communications network, a second communication that facilitates a display of said second map on said second user device.

10. The method of claim 9, wherein said second communication is selected from the group consisting of (i) a message that contains a link to a storage that has said second map stored therein, and (ii) a message that includes an image of said second map.

11. A storage medium comprising instructions stored therein in a form that is readable by a processor, wherein said instructions, when read by said processor, cause said processor to perform actions of:
receiving a text message that was sent from a first user device via a communications network;
detecting a text string in said text message;
executing a process, in response to said detecting said text string, wherein said executing yields a result; and
sending said result to a second user device via said communications network.

12. The storage medium of claim 11,
wherein said process comprises:
obtaining a location of said first user device; and
obtaining a map having said location indicated thereon, and
wherein said result comprises:
a communication that facilitates a display of said map on said second user device.

13. The storage medium of claim 12, wherein said communication is selected from the group consisting of (i) a message that contains a link to a storage that has said map stored therein, and (ii) a message that includes an image of said map.

14. The storage medium of claim 12,
wherein said text message is a first text message, said text string is a first text string, said map is a first map, and said communication is a first communication, and
wherein said instructions cause said processor to perform further actions of:
receiving a second text message that was sent from said second user device via said communications network;
detecting a second text string in said second text message;
obtaining, in response to said detecting said second text string, a location of said second user device;
obtaining a second map that shows a route from said location of said second user device to said location of said first user device; and
sending, to said second user device via said communications network, a second communication that facilitates a display of said second map on said second user device.

15. The storage medium of claim 14, wherein said second communication is selected from the group consisting of (i) a message that contains a link to a storage that has said second map stored therein, and (ii) a message that includes an image of said second map.
